(19) United States
(12) Patent Application Publication
(10) Pub. No.: US 2026/0303875 A1
(43) Pub. Date: Oct. 1, 2026

(54) METHOD AND APPARATUS OF UNIFIED CLASSIFICATION IN IN-LOOP FILTERING IN VIDEO CODING

(71) Applicant: MEDIATEK INC., Hsinchu City (TW)

(72) Inventors: Shih-Chun CHIU, Hsinchu City (TW); Yu-Cheng LIN, Hsinchu City (TW); Chih-Wei HSU, Hsinchu City (TW); Ching-Yeh CHEN, Hsinchu City (TW); Tzu-Der CHUANG, Hsinchu City (TW); Yi-Wen CHEN, San Jose, CA (US)

(21) Appl. No.: 19/472,652

(22) PCT Filed: Jul. 1, 2024
(86) PCT No.: PCT/CN2024/102866

§ 371 Date: Oct. 4, 2025

Related U.S. Application Data
(60) Provisional application No. 63/512,916, filed on Jul. 11, 2023.

(51) Int. Cl. H04N 19/82; H04N 19/117; H04N 19/176; H04N 19/436; H04N 19/70; H04N 19/86

(52) U.S. Cl. CPC H04N 19/82; H04N 19/117; H04N 19/176; H04N 19/436; H04N 19/70; H04N 19/86

(57) ABSTRACT

A method and apparatus for in-loop filtering of reconstructed video are disclosed. According to the method, input data for a current block is received, wherein the input data comprises reconstructed samples of the current block. At least two in-loop filters are applied to the current block, wherein said at least two in-loop filters belong to an in-loop filter group comprising BIF (Bilateral Filter) and ALF (Adaptive Loop Filter), and wherein classification processes of said at least two in-loop filters share an input source, one or more classification rules, one or more processing units, or a combination thereof. Filtered output generated by said applying said at least two in-loop filters to the current block is provided.

### CROSS REFERENCE TO RELATED APPLICATIONS

The present invention is a non-Provisional Application of and claims priority to U.S. Provisional Patent Application No. 63/512,916, filed on Jul. 11, 2023. The U.S. Provisional Patent Application is hereby incorporated by reference in its entirety.

### FIELD OF THE INVENTION

The present invention relates to video coding system using multiple in-loop filters including BIF (Bilateral Filter) and ALF (Adaptive Loop Filter). In particular, the present invention relates to unifying classification process for the multiple in-loop filters to reduce the complexity.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

### Adaptive Loop Filter in VVC

In VVC, an Adaptive Loop Filter (ALF) with block-based filter adaption is applied. For the luma component, one filter is selected among 25 filters for each 4×4 block, based on the direction and activity of local gradients.

### 1. Filter Shape

Two diamond filter shapes (as shown in FIG. 2) are used. The 7×7 diamond shape 220 is applied for luma component and the 5×5 diamond shape 210 is applied for chroma components.

### 2. Block Classification

For luma component, each 4×4 block is categorized into one out of 25 classes. The classification index C is derived based on its directionality D and a quantized value of activity Â, as follows:

$$C = 5 D + \hat{A} .$$

To calculate D and Â, gradients of the horizontal, vertical and two diagonal direction are first calculated using 1-D Laplacian:

$${g}_{v} = {{\sum }_{k = i - 2}}^{i + 3} {{\sum }_{l = j - 2}}^{j + 3} {V}_{k , l} , {V}_{k , l} = \vert 2 R ( k , l ) - R ( k , l - 1 ) - R ( k , l + 1 ) \vert ,$$

$${g}_{h} = {{\sum }_{k = i - 2}}^{i + 3} {{\sum }_{l = j - 2}}^{j + 3} {H}_{k , l} , {H}_{k , l} = \vert 2 R ( k , l ) - R ( k - 1 , l ) - R ( k + 1 , l ) \vert ,$$

$${g}_{d 1} = {{\sum }_{k = i - 2}}^{i + 3} {{\sum }_{l = j - 2}}^{j + 3} D {1}_{k , l} , D {1}_{k , l} = \vert 2 R ( k , l ) - R ( k - 1 , l - 1 ) - R ( k + 1 , l + 1 ) \vert ,$$

$${g}_{d 2} = {{\sum }_{k = i - 2}}^{i + 3} {{\sum }_{j = j - 2}}^{j + 3} D {2}_{k , l} , D {2}_{k , l} = \vert 2 R ( k , l ) - R ( k - 1 , l + 1 ) - R ( k + 1 , l - 1 ) \vert ,$$

where indices i and j refer to the coordinates of the upper left sample within the 4×4 block and R(i,j) indicates a reconstructed sample at coordinate (i,j).

To reduce the complexity of block classification, the subsampled 1-D Laplacian calculation is applied to the vertical direction (FIG. 3A) and the horizontal direction (FIG. 3B). As shown in FIGS. 3C-D, the same subsampled positions are used for gradient calculation of all directions (g_{d1} in FIG. 3C and g_{d2} in FIG. 3D).

Then D maximum and minimum values of the gradients of horizontal and vertical directions are set as:

$${g}_{h , v}^{max} = max ( {g}_{h} , {g}_{v} ) , {g}_{h , v}^{min} = min ( {g}_{h} , {g}_{v} ) .$$

The maximum and minimum values of the gradient of two diagonal directions are set as:

$${g}_{d 0 , d 1}^{max} = max ( {g}_{d 0} , {g}_{d 1} ) , {g}_{d 0 , d 1}^{min} = min ( {g}_{d 0} , {g}_{d 1} ) .$$

To derive the value of the directionality D, these values are compared against each other and with two thresholds t₁ and t₂:
Step 1. If both

$${g}_{h , v}^{max} \leq {t}_{1} \cdot {g}_{h , v}^{min} and {g}_{d 0 , d 1}^{max} \leq {t}_{1} \cdot {g}_{d 0 , d 1}^{min}$$

are true, D is set to 0.
Step 2. If

$${g}_{h , v}^{max} / {g}_{h , v}^{min} > {g}_{d 0 , d 1}^{max} / {g}_{d 0 , d 1}^{min} ,$$

continue from Step 3; otherwise continue from Step 4.
Step 3. If

$${g}_{h , v}^{max} > {t}_{2} \cdot {g}_{h , v}^{min} ,$$

D is set to 2; otherwise D is set to 1.
Step 4. If

$${g}_{d 0 , d 1}^{max} > {t}_{2} \cdot {g}_{d 0 , d 1}^{min} ,$$

D is set to 4; otherwise D is set to 3.

The activity value A is calculated as:

$$A = {\sum }_{k = i - 2}^{i + 3} {\sum }_{l = j - 2}^{j + 3} ( {V}_{k , l} + {H}_{k , l} ) .$$

A is further quantized to the range of 0 to 4, inclusively, and the quantized value is denoted as Â.

For chroma components in a picture, no classification is applied.

### 3. Geometric Transformations of Filter Coefficients and Clipping Values

Before filtering each 4×4 luma block, geometric transformations such as rotation or diagonal and vertical flipping are applied to the filter coefficients f(k, l) and to the corresponding filter clipping values c(k, l) depending on gradient values calculated for that block. This is equivalent to applying these transformations to the samples in the filter support region. The idea is to make different blocks to which ALF is applied more similar by aligning their directionality.

Three geometric transformations, including diagonal, vertical flip and rotation are introduced:

$$Diagonal : {f}_{D} ( k , l ) = f ( l , k ) , {c}_{D} ( k , l ) = c ( l , k ) ,$$

$$Vertical flip : {f}_{V} ( k , l ) = f ( k , K - l - 1 ) , {c}_{V} ( k , l ) = c ( k , K - l - 1 ) ,$$

$$Rotation : {f}_{R} ( k , l ) = f ( K - l - 1 , k ) , {c}_{R} ( k , l ) = c ( K - l - 1 , k ) ,$$

where K is the size of the filter and 0≤k, l≤K−1 are coefficients coordinates, such that location (0,0) is at the upper left corner and location (K−1, K−1) is at the lower right corner. The transformations are applied to the filter coefficients f (k, l) and to the clipping values c(k, l) depending on gradient values calculated for that block. The relationship between the transformation and the four gradients of the four directions are summarized in the following table.

TABLE 1
Mapping of the gradient calculated for
one block and the transformations

| Gradient values | Transformation | Transpose indexes |
|---|---|---|
| g_{d2} < g_{d1} and gₕ < gᵥ | No transformation | 0 |
| g_{d2} < g_{d1} and gᵥ < gₕ | Diagonal | 1 |
| g_{d1} < g_{d2} and gₕ < gᵥ | Vertical flip | 2 |
| g_{d1} < g_{d2} and gᵥ < gₕ | Rotation | 3 |

### 4. Filtering Process

At decoder side, when ALF is enabled for a CTB, each sample R(i,j) within the CU is filtered, resulting in sample value R′(i,j) as shown below,

$${R}^{′} ( i , j ) = R ( i , j ) + ( ( {\sum }_{k \neq 0} {\sum }_{l \neq 0} f ( k , l ) \times K ( R ( i + k , j + l ) - R ( i , j ) , c ( k , l ) ) + 64 ) ≫ 7. )$$

where f(k, l) denotes the decoded filter coefficients, K(x, y) is the clipping function and c(k, l) denotes the decoded clipping parameters. The variable k and l varies between −L/2 and L/2, where L denotes the filter length. The clipping function K(x, y)=min(y, max(−y, x)) which corresponds to the function Clip3 (−y, y, x). The clipping operation introduces non-linearity to make ALF more efficient by reducing the impact of neighbour sample values that are too different with the current sample value.

### 5. Cross Component Adaptive Loop Filter

CC-ALF uses luma sample values to refine each chroma component by applying an adaptive, linear filter to the luma channel and then using the output of this filtering operation for chroma refinement. FIG. 4A provides a system level diagram of the CC-ALF process with respect to the SAO, luma ALF and chroma ALF processes. As shown in FIG. 4A, each colour component (i.e., Y, Cb and Cr) is processed by its respective SAO (i.e., SAO Luma 410, SAO Cb 412 and SAO Cr 414). After SAO, ALF Luma 420 is applied to the SAO-processed luma and ALF Chroma 430 is applied to SAO-processed Cb and Cr. However, there is a cross-component term from luma to a chroma component (i.e., CC-ALF Cb 422 and CC-ALF Cr 424). The outputs from the cross-component ALF are added (using adders 432 and 434 respectively) to the outputs from ALF Chroma 430.

Filtering in CC-ALF is accomplished by applying a linear, diamond shaped filter (e.g. filters 440 and 442 in FIG. 4B) to the luma channel. In FIG. 4B, a blank circle indicates a luma sample and a dot-filled circle indicate a chroma sample. One filter is used for each chroma channel, and the operation is expressed as:

$$Δ {I}_{i} ( x , y ) = {\sum }_{( {x}_{0} , {y}_{0} ) ∈ {S}_{i}} {I}_{0} ( {x}_{Y} + {x}_{0} , {y}_{Y} + {y}_{0} ) {c}_{i} ( {x}_{0} , {y}_{0} )$$

where (x, y) is chroma component i location being refined, (x_{Y}, y_{Y}) is the luma location based on (x, y), Sᵢ is filter support area in luma component, and cᵢ(x₀, y₀) represents the filter coefficients.

As shown in FIG. 4B, the luma filter support is the region collocated with the current chroma sample after accounting for the spatial scaling factor between the luma and chroma planes.

In the VVC reference software, CC-ALF filter coefficients are computed by minimizing the mean square error of each chroma channel with respect to the original chroma content. To achieve this, the VTM (VVC Test Model) algorithm uses a coefficient derivation process similar to the one used for chroma ALF. Specifically, a correlation matrix is derived, and the coefficients are computed using a Cholesky decomposition solver in an attempt to minimize a mean square error metric. In designing the filters, a maximum of 8 CC-ALF filters can be designed and transmitted per picture. The resulting filters are then indicated for each of the two chroma channels on a CTU basis.

Additional characteristics of CC-ALF include:
The design uses a 3×4 diamond shape with 8 taps.
Seven filter coefficients are transmitted in the APS.
Each of the transmitted coefficients has a 6-bit dynamic range and is restricted to power-of-2 values.
The eighth filter coefficient is derived at the decoder such that the sum of the filter coefficients is equal to 0.
An APS may be referenced in the slice header.
CC-ALF filter selection is controlled at CTU-level for each chroma component
Boundary padding for the horizontal virtual boundaries uses the same memory access pattern as luma ALF.

As an additional feature, the reference encoder can be configured to enable some basic subjective tuning through the configuration file. When enabled, the VTM attenuates the application of CC-ALF in regions that are coded with high QP and are either near mid-grey or contain a large amount of luma high frequencies. Algorithmically, this is accomplished by disabling the application of CC-ALF in CTUs where any of the following conditions are true:
The slice QP value minus 1 is less than or equal to the base QP value.
The number of chroma samples for which the local contrast is greater than (1<<(bitDepth−2))−1 exceeds the CTU height, where the local contrast is the difference between the maximum and minimum luma sample values within the filter support region.
More than a quarter of chroma samples are in the range between

$$( 1 << ( bitDepth - 1 ) ) - 16 and ( 1 << ( bitDepth - 1 ) ) + 16$$

The motivation for this functionality is to provide some assurance that CC-ALF does not amplify artefacts introduced earlier in the decoding path (This is largely due the fact that the VTM currently does not explicitly optimize for chroma subjective quality). It is anticipated that alternative encoder implementations may either not use this functionality or incorporate alternative strategies suitable for their encoding characteristics.

### 6. Filter Parameters Signalling

ALF filter parameters are signalled in Adaptation Parameter Set (APS). In one APS, up to 25 sets of luma filter coefficients and clipping value indexes, and up to eight sets of chroma filter coefficients and clipping value indexes can be signalled. To reduce bits overhead, filter coefficients of different classification for luma component can be merged. In slice header, the indices of the APSs used for the current slice are signalled.

Clipping value indexes, which are decoded from the APS, allow determining clipping values using a table of clipping values for both luma and Chroma components. These clipping values are dependent of the internal bitdepth. More precisely, the clipping values are obtained by the following formula:

$$A l f C l i p = \{ round ( {2}^{B - α * n} ) for n ∈ [ 0 … N - 1 ] \}$$

with B equal to the internal bitdepth, a is a pre-defined constant value equal to 2.35, and N equal to 4 which is the number of allowed clipping values in VVC. The AlfClip is then rounded to the nearest value with the format of power of 2.

In slice header, up to 7 APS indices can be signalled to specify the luma filter sets that are used for the current slice. The filtering process can be further controlled at CTB level. A flag is always signalled to indicate whether ALF is applied to a luma CTB. A luma CTB can choose a filter set among 16 fixed filter sets and the filter sets from APSs. A filter set index is signalled for a luma CTB to indicate which filter set is applied. The 16 fixed filter sets are pre-defined and hard-coded in both the encoder and the decoder.

For the chroma component, an APS index is signalled in slice header to indicate the chroma filter sets being used for the current slice. At CTB level, a filter index is signalled for each chroma CTB if there is more than one chroma filter set in the APS.

The filter coefficients are quantized with norm equal to 128. In order to restrict the multiplication complexity, a bitstream conformance is applied so that the coefficient value of the non-central position shall be in the range of −2⁷ to 2⁷−1, inclusive. The central position coefficient is not signalled in the bitstream and is considered as equal to 128.

### Adaptive Loop Filter in ECM

In ECM8 (Muhammed Coban, et al., “Algorithm description of Enhanced Compression Model 8 (ECM 8)”, Joint Video Experts Team (JVET) of ITU-T SG 16 WP 3 and ISO/IEC JTC 1/SC 29), 29th Meeting, by teleconference, 11-20 Jan. 2023, Document: JVET-AC2025), some changes from the VVC ALF are disclosed. A brief overview is shown below.

### 1. ALF Simplification Removal

ALF gradient subsampling and ALF virtual boundary processing are removed. Block size for classification is reduced from 4×4 to 2×2. Filter size for both luma and chroma, for which ALF coefficients are signalled, is increased to 9×9.

2. ALF with Fixed Filters

To filter a luma sample, three different classifiers (C₀, C₁ and C₂) and three different sets of filters (F₀, F₁ and F₂) are used. Sets F₀ and F₁ contain fixed filters, with coefficients trained for classifiers C₀ and C₁. Coefficients of filters in F₂ are signalled. Which filter from a set Fᵢ is used for a given sample is decided by a class Cᵢ assigned to this sample using classifier Cᵢ.

### 3. Filtering

At first, two 13×13 diamond shape fixed filters F₀ and F₁ are applied to derive two intermediate samples R₀(x, y) and R₁(x, y). After that, F₂ is applied to R₀(x, y), R₁(x, y), and neighbouring samples to derive a filtered sample as

$$\tilde{R} ( x , y ) = R ( x , y ) + [ {\sum }_{i = 0}^{19} {c}_{i} ( {f}_{i , 0} + {f}_{i , 1} ) ] + [ {\sum }_{i = 20}^{21} {c}_{i} {g}_{i} ] ,$$

where f_{i,j} is the clipped difference between a neighbouring sample and current sample R(x, y) and gᵢ is the clipped difference between Rᵢ₋₂₀(x, y) and current sample. The filter coefficients cᵢ, i=0, . . . 21, are signalled.

### 4. Classification

Based on directionality Dᵢ and activity Âᵢ, a class Cᵢ is assigned to each 2×2 block:

$${C}_{i} = {\hat{A}}_{i} * {M}_{D , i} + {D}_{i} ,$$

where M_{D,i} represents the total number of directionalities Dᵢ.

As in VVC, values of the horizontal, vertical, and two diagonal gradients are calculated for each sample using 1-D Laplacian. The sum of the sample gradients within a 4×4 window that covers the target 2×2 block is used for classifier C₀ and the sum of sample gradients within a 12×12 window is used for classifiers C₁ and C₂. The sums of horizontal, vertical and two diagonal gradients are denoted, respectively, as

$${g}_{h}^{i} , {g}_{v}^{i} , {g}_{d 1}^{i} and {g}_{d 2}^{i} .$$

The directionality Dᵢ is determined by comparing

$${r}_{h , v}^{i} = \frac{max ( {g}_{h}^{i} , {g}_{v}^{i} )}{min ( {g}_{h}^{i} , {g}_{v}^{i} )} , {r}_{d 1 , d 2}^{i} = \frac{max ( {g}_{d 1}^{i} , {g}_{d 2}^{i} )}{min ( {g}_{d 1}^{i} , {g}_{d 2}^{i} )} ,$$

with a set of thresholds. The directionality D₂ is derived as in VVC using thresholds 2 and 4.5. For D₀ and D₁, horizontal/vertical edge strength

$${E}_{H V}^{i}$$

and diagonal edge strength

$${E}_{D}^{i}$$

are calculated first. Thresholds Th=[1.25, 1.5, 2, 3, 4.5, 8] are used. Edge strength

$${E}_{D}^{i}$$

$${r}_{d 1 , d 2}^{i} \leq Th [ 0 ] ;$$

is 0 if

$${r}_{h , v}^{i} \leq Th [ 0 ] ;$$

otherwise,

$${E}_{H V}^{i}$$

is the maximum integer such that

$${r}_{h , v}^{i} > T h [ {E}_{H V}^{i} - 1 ] .$$

Edge strength

$${E}_{H V}^{i}$$

otherwise,

$${E}_{D}^{i}$$

is the maximum integer such that

$${r}_{d 1 , d 2}^{i} > Th [ {E}_{D}^{i} - 1 ] .$$

### When

$${r}_{h , v}^{i} > {r}_{d 1 , d 2}^{i} ,$$

i.e.
horizontal/vertical edges are dominant, the Dᵢ is derived by using Table 2A; otherwise, diagonal edges are dominant, the Dᵢ is derived by using Table 2B.

TABLE 2A
$Mapping of {E}_{D}^{i} and {E}_{HV}^{i} to {D}_{i}$

| | ${E}_{D}^{i}$ | | | | | | |
|---|---|---|---|---|---|---|---|
| ${E}_{HV}^{i}$ | 0 | 1 | 2 | 3 | 4 | 5 | 6 |
| 0 | 0 | 0 | 0 | 0 | 0 | 0 | 0 |
| 1 | 1 | 2 | 0 | 0 | 0 | 0 | 0 |
| 2 | 3 | 4 | 5 | 0 | 0 | 0 | 0 |
| 3 | 6 | 7 | 8 | 9 | 0 | 0 | 0 |
| 4 | 10 | 11 | 12 | 13 | 14 | 0 | 0 |
| 5 | 15 | 16 | 17 | 18 | 19 | 20 | 0 |
| 6 | 21 | 22 | 23 | 24 | 25 | 26 | 27 |

TABLE 2B
$Mapping of {E}_{D}^{i} and {E}_{HV}^{i} to {D}_{i}$

| | ${E}_{HV}^{i}$ | | | | | | |
|---|---|---|---|---|---|---|---|
| ${E}_{D}^{i}$ | 0 | 1 | 2 | 3 | 4 | 5 | 6 |
| 0 | 28 | 0 | 0 | 0 | 0 | 0 | 0 |
| 1 | 29 | 30 | 0 | 0 | 0 | 0 | 0 |
| 2 | 31 | 32 | 33 | 0 | 0 | 0 | 0 |
| 3 | 34 | 35 | 36 | 37 | 0 | 0 | 0 |
| 4 | 38 | 39 | 40 | 41 | 42 | 0 | 0 |
| 5 | 43 | 44 | 45 | 46 | 47 | 48 | 0 |
| 6 | 49 | 50 | 51 | 52 | 53 | 54 | 55 |

To obtain Âᵢ, the sum of vertical and horizontal gradients Aᵢ is mapped to the range of 0 to n, where n is equal to 4 for Â₂ and 15 for Â₀ and Â₁.

In an ALF_APS, up to 4 luma filter sets are signalled, each set may have up to 25 filters.

### 5. Alternative 2×2 ALF Classifier

Classification in ALF is extended with an additional alternative classifier. For a signalled luma filter set, a flag is signalled to indicate whether the alternative classifier is applied. Geometrical transformation is not applied to the alternative band classifier. When the band-based classifier is applied, the sum of sample values of a 2×2 luma block is calculated at first. Then the class index is calculated as below,

$$class\_index = ( sum * 25 ) ≫ ( sample bit depth + 2 ) .$$

### 6. Residual Based Classifier

A third classifier is based on luma residual sample values. For each 2×2 luma block, the sum of absolute values of the residual samples in a neighbouring 8×8 window is calculated, and the class index is derived as:

$$classIdx = sum ≫ ( sample bit depth - 4 ) .$$

The value of classIdx is in the range of 0 to 24, same as in ECM-8.0. The classifier usage is signalled for each luma filter set in APS.

7. CCALF with Long Tap Filter

The CCALF process uses a linear filter to filter luma sample values and generate a residual correction for the chroma samples. A 25-tap large filter is used in CCALF process, which is illustrated in FIG. 5. In FIG. 5, taps for luma samples are shown in grey dots and the location of the corresponding chroma sample is shown as a small dash-lined circle. For a given slice, the encoder can collect the statistics of the slice, analyse them and can signal up to 16 filters through APS.

### 8. Adaptive Filter Shape Switch/Using Samples Before Deblocking Filter for ALF

Two candidate filter shapes: a diamond shape as shown in FIG. 6 and a new cross shape as shown in FIG. 7, can be adaptively selected by the luma filters in ALF. The number of coefficients of a luma filter is 22 for both the filter shapes. Please note that these 22 taps are constituted with 20 spatial taps (610 and 710 in FIG. 6 and FIG. 7 respectively) and 2 fixed filters based taps (620 and 720 in FIG. 6 and FIG. 7 respectively) in both shapes.

In each Adaptation Parameter Set (APS), a shape index for the derived luma filters is signalled to the decoder. Each APS contains the luma filters that are associated with the filter shape index.

For each CTB, an APS index is signalled to indicate which luma filter shape is used to filter the current CTB. When filtering a luma sample, the coefficients and clip indices are also rearranged according to the corresponding filter shape.

The diamond shape luma ALF is replaced by the longer filter shown in FIG. 7.

The samples before deblocking filters are used as additional inputs for ALF. A final ALF sample is derived by weighting the regular ALF and the filter applied to the samples before the deblocking filter. Specifically, a filtered sample is derived as

$$\tilde{R} ( x , y ) = R ( x , y ) + [ {{\sum }_{i = 0}}^{19} {c}_{i} ( {f}_{i , 0} + {f}_{i , 1} ) ] + [ {{\sum }_{i = 20}}^{21} {c}_{i} {g}_{i} ] + [ {{\sum }_{i = 22}}^{N} {c}_{i} ( {h}_{i , 0} + {h}_{i , 1} ) ]$$

where f_{i,j} is the clipped difference between a neighbouring sample and current sample R(x, y), gᵢ is the clipped difference between an intermediate sample and current sample R(x, y) and h_{i,j} is the clipped difference between a neighbouring sample before DBF and current sample R(x, y). The filter coefficients cᵢ, i=0, . . . 24 are signalled. In example, 3×3 diamond shape is applied to samples before deblocking filter. In an APS, a flag is signalled to indicate whether samples before DBF are used for ALF which is always set as true at encoder.

### 9. Extended Fixed-Filter-Output Based Taps for ALF

In ALF online-trained filters consist of 4 kinds of filter taps: spatial taps (810), reconstruction-before-DBF based taps (840), residual based taps (850) and fixed-filter-output based taps (820 and 830) as shown in FIG. 8.

10. ALF with Residual Samples

The residual samples are used as additional inputs to the ALF. A filtered sample is derived as:

$$\tilde{R} ( x , y ) = R ( x , y ) + [ {{\sum }_{i = 0}}^{19} {c}_{i} ( {f}_{i , 0} + {f}_{i , 1} ) ] + [ {{\sum }_{i = 20}}^{25} {c}_{i} ( {g}_{i , 0} + {g}_{i , 1} ) ] + [ {{\sum }_{i = 26}}^{27} {c}_{i} ( {h}_{i , 0} + {h}_{i , 1} ) ] + [ {{\sum }_{i = 28}}^{29} {c}_{i} {g}_{i} ] + [ {{\sum }_{i = 30}}^{30} {c}_{i} {h}_{i} ] + [ {{\sum }_{i = 31}}^{31} {c}_{i} {r}_{i} ] + [ {{\sum }_{i = 32}}^{32} {c}_{i} {rFiltered}_{i} ] .$$

where rᵢ is the clipped neighbouring residual sample value and rFilteredᵢ is the clipped residual sample filtered by the fixed-filter. For residual samples, the fixed filter reuses the offline fixed filter trained for reconstruction after SAO.

### 11. Additional Fixed Filter for ALF

Additional fixed filter with a shape of diamond 7×7 is introduced, the filter parameters are stored at both the encoder and the decoder. There is no classification for the newly added fixed filter.

An online filter or online-trained filter of the proposed method is shown in FIG. 9, where spatial taps 910 (i.e., tap #0~#19), reconstruction-before-DBF-based taps 940 (i.e., tap #26, #27, #36), residual-based taps 950 (i.e., #37~#38) and fixed-filter-output-based taps 920 and 930 (i.e., tap #20~#25, #34, #35) are kept the same as the ECM-8.0, and several extended taps 960 (i.e., tap #28∥#33, #39) are introduced into luma online-trained filters. The reconstruction before DBF is fed into the additional fixed filter to produce the filter outputs, then these filter outputs are used as input for newly extended taps. The online filter or online-trained filter refers to a filter specified in APS (Adaptation Parameter Set), where the filter is trained at the encoder and signalled to decoder. The online filter or online-trained filter is in contrast to fixed filters, which are offline-trained and pre-defined in the specification.

This filter is always enabled without any filter shape switching.

### 12. Improved Fixed Filters for ALF (JVET-AE0139)

In JVET-AE0139 (Marta Karczewicz, et al., “EE2-5.2: Improved fixed filters for ALF”, Joint Video Experts Team (JVET) of ITU-T SG 16 WP 3 and ISO/IEC JTC 1/SC 29), 31st Meeting, Geneva, CH, 11-19 Jul. 2023, Document: JVET-AE0139), improved fixed filters for ALF are disclosed. According to JVET-AE0139, both fixed filters are applied to samples before DBF and ALF input, where additional diamond 9×9 filter is used for the samples before DBF. The shape of the first fixed filter applied to the ALF input samples is reduced from 13×13 to 9×9, and the shape of the second fixed filter, which is 13×13, applied to ALF input is unchanged as shown in the Table 3.

TABLE 3
Comparison of fixed filters between ECM-9.0 and JVET-AE0139

JVET-AE0139

| | ECM-9.0 | Samples | ALF |
|---|---|---|---|
| | ALF input | before DBF | input |
| Fixed filer f₀ | 13 × 13 | 9 × 9 | 9 × 9 |
| Fixed filer f₁ | 13 × 13 | 9 × 9 | 13 × 13 |

The classifiers of the fixed filters are extended. For each 2×2 block, the mean value of a surrounding window is calculated. Then, for each sample of this window, the difference between the sample value and the mean value is calculated. A scaling factor is determined based on the activity value derived from a Laplacian classifier. The square root of the sum of the squared differences is further quantized to C′ by a scaling factor. The value of C′ is an integer between 0 and 7, inclusively. With i=0, 1, let Cᵢ denote the classifier from the classifier of i-th fixed filter in ECM-9.0. Then the proposed class index

$${C}_{i}^{′}$$

is derived as

$${C}_{i}^{′} = {C}^{′} * 896 + {C}_{i} .$$

In the proposal of JVET-AE0139, the total number of the fixed filters is not changed. Fixed filter f₁ is applied to outputs of f₀ (instead of ALF input) and samples before DBF.

### Bilateral Filter in ECM

The filter is carried out in the sample adaptive offset (SAO) loop-filter stage, as shown in FIG. 10. Both the bilateral filter (BIF) 1010 and SAO 1020 are using samples from deblocking as input. Each filter creates an offset per sample, and these are added using adder 1030 to the input sample and then clipped, before proceeding to ALF.

In detail, the output sample I_{OUT} is obtained as

$${I}_{OUT} = clip 3 ( {I}_{C} + Δ {I}_{BIF} + Δ {I}_{SAO} ) ,$$

where I_{C} is the input sample from deblocking, ΔI_{BIF} is the offset from the bilateral filter and ΔI_{SAO} is the offset from SAO.

The implementation provides the possibility for the encoder to enable or disable filtering at the CTU and slice level. The encoder takes a decision by evaluating the RDO cost.

For CTUs that are filtered, the filtering process proceeds as follows.

At the picture border, where samples are unavailable, the bilateral filter uses extension (sample repetition) to fill in unavailable samples. For virtual boundaries, the behaviour is the same as for SAO, i.e., no filtering occurs. When crossing horizontal CTU borders, the bilateral filter can access the same samples as SAO is accessing. As an example, if the centre sample I_{C}, as shown in FIG. 11, is located on the top line of a CTU, I_{NW}, I_{A} and I_{NE} are read from the CTU above, just like SAO does, but I_{AA} is padded, so no extra line buffer is needed compared to JVET-P0073 (Jacob Ström, et al., “CE5-3.1 Combination of bilateral filter and SAO”, Joint Video Experts Team (JVET) of ITU-T SG 16 WP 3 and ISO/IEC JTC 1/SC 29), 16th Meeting: Geneva, CH, 1-11 Oct. 2019, Document: JVET-P0073).

The samples surrounding the centre sample I_{C} are denoted according to FIG. 11, where A, B, L and R stands for above, below, left and right and where NW, NE, SW, SE stands for north-west etc. Likewise, AA stands for above-above, BB for below-below etc. This diamond shape is different from JVET-P0073 which used a square filter support, not using I_{AA}, I_{BB}, I_{LL}, or I_{RR}.

Each surrounding sample I_{A}, I_{R} etc. will contribute with a corresponding modifier value μ_{ΔI}_{_{A}}, μ_{ΔI}_{_{R}}, etc. These are calculated in the following way: Starting with the contribution from the sample to the right, I_{R}, we calculate the difference:

$$Δ {I}_{R} = ( \vert {I}_{R} - {I}_{C} \vert + 4 ) ≫ 3 ,$$

where |⋅| denotes absolute value. For data that is not 10-bit, we use ΔI_{R}=(|I_{R}−I_{C}|+2ⁿ⁻⁶)>>(n−7) instead, where n=8 for 8-bit data etc. The resulting value is now clipped so that it is smaller than 16:

$${sI}_{R} = min ( 15 , Δ {I}_{R} ) .$$

The modifier value is now calculated as:

$${μ}_{Δ {I}_{R}} = \{ \begin{matrix}{LUT}_{ROW} [ {sI}_{R} ] , & if {I}_{R} - {I}_{C} \geq 0 , \\ - {LUT}_{ROW} [ {sI}_{R} ] & otherwise\end{matrix}$$

where LUT_{ROW}[ ] is an array of 16 values determined by the value of qpb=clip(0, 25, QP+bilateral_filter_qp_offset−17):
{0, 0, 0, 0, 0, 0, 0, 0, 0, 0, 0, 0, 0, 0, 0, 0,}, if qpb=0
{0, 1, 1, 1, 1, 0, 0, 0, 0, 0, 0, 0, 0, 0, 0, 0,}, if qpb=1
{0, 2, 2, 2, 1, 1, 0, 1, 0, 0, 0, 0, 0, 0, 0, 0,}, if qpb=2
{0, 2, 2, 2, 2, 1, 1, 1, 1, 1, 1, 1, 0, 1, 1, −1,}, if qpb=3
{0, 3, 3, 3, 2, 2, 1, 2, 1, 1, 1, 1, 0, 1, 1, −1,}, if qpb=4
{0, 4, 4, 4, 3, 2, 1, 2, 1, 1, 1, 1, 0, 1, 1, −1,}, if qpb=5
{0, 5, 5, 5, 4, 3, 2, 2, 2, 2, 2, 1, 0, 1, 1, −1, 1}, if qpb=6
{0, 6, 7, 7, 5, 3, 3, 3, 3, 2, 2, 1, 1, 1, 1, −1,}, if qpb=7
{0, 6, 8, 8, 5, 4, 3, 3, 3, 3, 3, 2, 1, 2, 2, −2, 1}, if qpb=8
{0, 7, 10, 10, 6, 4, 4, 4, 4, 3, 3, 2, 2, 2, 2, −2,}, if qpb=9
{0, 8, 11, 11, 7, 5, 5, 4, 5, 4, 4, 2, 2, 2, 2, −2, 1}, if qpb=10
{0, 8, 12, 13, 10, 8, 8, 6, 6, 6, 5, 3, 3, 3, 3, −2,}, if qpb=11
{0, 8, 13, 14, 13, 12, 11, 8, 8, 7, 7, 5, 5, 4, 4, −2,}, if qpb=12
{0, 9, 14, 16, 16, 15, 14, 11, 9, 9, 8, 6, 6, 5, 6, −3,}, if qpb=13
{0, 9, 15, 17, 19, 19, 17, 13, 11, 10, 10, 8, 8, 6, 7, −3,}, if qpb=14
{0, 9, 16, 19, 22, 22, 20, 15, 12, 12, 11, 9, 9, 7, 8, −3,}, if qpb=15
{0, 10, 17, 21, 24, 25, 24, 20, 18, 17, 15, 12, 11, 9, 9, −3,}, if qpb=16
{0, 10, 18, 23, 26, 28, 28, 25, 23, 22, 18, 14, 13, 11, 11, −3,}, if qpb=17
{0, 11, 19, 24, 29, 30, 32, 30, 29, 26, 22, 17, 15, 13, 12, −3,}, if qpb=18
{0, 11, 20, 26, 31, 33, 36, 35, 34, 31, 25, 19, 17, 15, 14, −3,}, if qpb=19
{0, 12, 21, 28, 33, 36, 40, 40, 40, 36, 29, 22, 19, 17, 15, −3,}, if qpb=20
{0, 13, 21, 29, 34, 37, 41, 41, 41, 38, 32, 23, 20, 17, 15, −3,}, if qpb=21
{0, 14, 22, 30, 35, 38, 42, 42, 42, 39, 34, 24, 20, 17, 15, −3,}, if qpb=22
{0, 15, 22, 31, 35, 39, 42, 42, 43, 41, 37, 25, 21, 17, 15, −3,}, if qpb=23
{0, 16, 23, 32, 36, 40, 43, 43, 44, 42, 39, 26, 21, 17, 15, −3,}, if qpb=24
{0, 17, 23, 33, 37, 41, 44, 44, 45, 44, 42, 27, 22, 17, 15, −3,}, if qpb=25

This is different from JVET-P0073, where 5 such tables were used, and the same table was reused for several qp-values.

As described in JVET-N0493 (Jacob Ström, et al., “CE1-related: Multiplication-free bilateral loop filter”, Joint Video Experts Team (JVET) of ITU-T SG 16 WP 3 and ISO/IEC JTC 1/SC 29), 14th Meeting: Geneva, CH, 19-27 Mar. 2019, Document: JVET-N0493) section 3.1.3, these values can be stored using six bits per entry resulting in 26*16*6/8=312 bytes or 300 bytes if the first row being all zeros is excluded.

The modifier values μ_{ΔI}_{_{L}}, μ_{ΔI}_{_{A}} and μ_{ΔI}_{_{B}} are calculated from I_{L}, I_{A} and I_{B} in the same way. For diagonal samples I_{NW}, I_{NE}, I_{SE}, I_{SW}, and the samples two steps away I_{AA}, I_{BB}, I_{RR} and I_{LL}, the calculation also follows Equations 2 and 3, but uses a value shifted by 1. Using the diagonal sample I_{SE} as an example, we get

$${μ}_{Δ {I}_{SE}} = \{ \begin{matrix}{LUT}_{ROW} [ {sI}_{SE} ] ≫ 1 , & if {I}_{SE} - {I}_{C} \geq 0 , \\ - ( {LUT}_{ROW} [ {sI}_{SE} ] ≫ 1 ) & otherwise\end{matrix}$$

and the other diagonal samples and two-steps-away samples are calculated likewise. The modifier values are summed together:

$${m}_{s u m} = {μ}_{Δ {I}_{A}} + {μ}_{Δ {I}_{B}} + {μ}_{Δ {I}_{L}} + {μ}_{Δ {I}_{R}} + {μ}_{Δ {I}_{N W}} + {μ}_{Δ {I}_{N E}} + {μ}_{Δ {I}_{S W}} + {μ}_{Δ {I}_{S E}} + {μ}_{Δ {I}_{A A}} + {μ}_{Δ {I}_{B B}} + {μ}_{Δ {I}_{L L}} + {μ}_{Δ {I}_{R R}} .$$

Note that μ_{ΔI}_{_{R}} equals −μ_{ΔI}_{_{A}} the previous sample. Likewise, μ_{ΔI}_{_{A}} equals −μ_{ΔI}_{_{B}} for the example above, and similar symmetries can also be found for the diagonal and two-steps-away modifier values. This means that in a hardware implementation, it is sufficient to calculate the six values μ_{ΔI}_{_{R}}, μ_{ΔI}_{_{B}}, μ_{ΔI}_{_{SW}}, μ_{ΔI}_{_{SE}}, μ_{ΔI}_{_{RR}} and μ_{ΔI}_{_{BB}} and the remaining six values can be obtained from previously calculated values.

The mₛᵤₘ value is now multiplied either by c=1, 2 or 3, which can be done using a single adder and logical AND gates in the following way:

$${c}_{v} = {k}_{1} \& ( {m}_{s u m} ≪ 1 ) + {k}_{2} \& {m}_{sum} ,$$

where & denotes logical and k₁ is the most significant bit of the multiplier c and k₂ is the least significant bit. The value to multiply with is obtained using the minimum block dimension D=min(width, height) as shown in the following table.

TABLE 4
Obtaining the c parameter from the minimum
size D = min(width, height) of the block.

| Block type | D ≤ 4 | 4 < D < 16 | D ≥ 16 |
|---|---|---|---|
| Intra | 3 | 2 | 1 |
| Inter | 2 | 2 | 1 |

Finally, the bilateral filter offset ΔI_{BIF} is calculated. For full strength filtering, we use

$$Δ {I}_{BIF} = ( {c}_{v} + 16 ) ≫ 5 ,$$

whereas for half-strength filtering, we instead use

$$Δ {I}_{BIF} = ( {c}_{v} + 32 ) ≫ 6.$$

A general formula for n-bit data is to use

$${r}_{a d d} = {2}^{14 - n - bilateral \_ filter \_ strength}$$

$${r}_{s hift} = 15 - n - bilateal\_filter \_strength$$

$$Δ {I}_{BIF} = ( {c}_{v} + {r}_{a d d} ) ≫ {r}_{shift} ,$$

where bilateral_filter_strength can be 0 or 1 and is signalled in the PPS (Picture Parameter Set).
Bilateral in-Loop Filter on Chroma

Same as BIF-luma, BIF-chroma 1210 is also performed in parallel with the SAO and CCSAO process as shown in FIG. 12. BIF-chroma 1210, CCSAO 1230 and SAO 1220 use the same chroma samples produced by the deblocking filter as input and generate three offsets per chroma sample in parallel. Then these three offsets are added using adder 1240 to the input chroma sample to obtain a sum, which is then clipped to form the final output chroma sample value. The BIF-chroma provides an on/off control mechanism on CTU level and slice level.

The filtering process of BIF-chroma is similar to that of BIF-luma. For a chroma sample, a 5×5 diamond shape filter is used for generating the filtering offset. The difference between the central sample and each surrounding sample is calculated first. The coefficient for each reference sample is extracted from a pre-defined look-up-table based on the calculated difference directly. The coefficients used for chroma components are retrained, different from those from BIF-luma. In the BIF-luma design, the block-level filtering strength parameter c is determined based on luma TU size and CU mode. While in the BIF-chroma design, the parameter for chroma components is determined based the chroma TU size and mode when dual-tree partitioning is enabled for the current slice and based on the corresponding luma TU size and mode when dual-tree partitioning is disabled.

### Dynamic Scaling of Bilateral Filter (JVET-AE0044)

As proposed in JVET-AE0044 (V. Shchukin, et al., “AHG12: Dynamic Scaling of Bilateral Filter (BIF)”, Joint Video Experts Team (JVET) of ITU-T SG 16 WP 3 and ISO/IEC JTC 1/SC 29), 31st Meeting, Geneva, CH, 11-19 Jul. 2023, Document: JVET-AE0044), the base LUT size is preserved, but the content of the base LUT is changed and the calculation of μ_{ΔI}_{_{R}} is also changed. The proposed method uses three scale factors (C_{1,0}, C_{1,1} and C_{2,0}) to pre-compute three LUTs for three different neighbor distances (1, \sqrt{2}, and 2), i.e.:

$$L U {T}_{i , j , R O W} [ k ] = ( {C}_{i , j} \cdot {LUT}_{R O W} [ k ] + 4 ) ≫ 3 , ( for each qpb )$$

and the averaging linear interpolation for the half of the values of the cut off least significant bits, i.e.,:

$${μ}_{Δ {I}_{R}} = \{ \begin{matrix}( {v}_{1} + {v}_{2} + 1 ) ≫ 1 , & if {I}_{R} - {I}_{C} \geq 0 , \\ - ( ( {v}_{1} + {v}_{2} + 1 ) ≫ 1 ) & otherwise\end{matrix}$$

where v₁ and V₂ are successive entries of LUT_{i,j,ROW} [sI_{R}]. For chroma, the number of cutoff bits is decreased from 3 to 2.

In JVET-AE0044, the number of cut off bits in the following equation: ΔI_{BIF}=(cᵥ+16)>>5 is increased from 5 to 8 and

$${C}_{T U} = {C}_{w , h}^{T U} + {C}_{MAD}^{T U} ,$$

where

$${C}_{w , h}^{TU}$$

is based on the TU's shape sizes and

$${C}_{M A D}^{TU}$$

is based on the mean absolute difference (MAD) of the TU. Both

$${C}_{w , h}^{TU} and {C}_{M A D}^{TU}$$

are calculated using LUTs. More precisely, let LUT_{w,h} be a 2D 8×8 lookup table with non-negative 8-bit integer values, and let LUT_{MAD} be a 1D 16-entry lookup table with non-negative 8-bit integer values. Then these scale factors are defined as follows:

$${C}_{w , h}^{T U} = L U {T}_{w , h} ( {log}_{2} {width}_{T U} , {log}_{2} {height}_{T U} ) ,$$

$${C}_{M A D}^{T U} = L U {T}_{M A D} ( min ( M A {D}_{T U} ≫ 4 , 15 ) ) .$$

The MAD of a (h×w)-size TU with the channel samples denoted by s_{i,j} is defined as follows:

$$M A D = \frac{1}{h w} {\sum }_{i = 1}^{h} {\sum }_{j = 1}^{w} \vert {s}_{i , j} - \frac{1}{h w} {\sum }_{i = 1}^{h} {\sum }_{j = 1}^{w} {s}_{i , j} \vert .$$

In total, four 64-byte tables LUT_{w,h} and four 16-byte tables LUT_{MAD} are introduced (for luma/chroma component, for intra/inter prediction). Note that C_{TU} is a constant for all samples of the same channel inside one TU.

Variance-Based Classification for in-Loop Filtering (JVET-AE0131)

In JVET-AE0131 (W. Yin1, et al., “Non-EE2: Variance based Classification for In-loop Filtering”, Joint Video Experts Team (JVET) of ITU-T SG 16 WP 3 and ISO/IEC JTC 1/SC 29), 31st Meeting, Geneva, CH, 11-19 Jul. 2023, Document: JVET-AE0131), a variance-based classification for BIF and ALF is proposed.

For BIF, the variance of a TU is utilized to identify the texture strength. More filter strengths are introduced into BIF. The filtering strength is determined by the variance.

For ALF, each classification unit is classified into 2 levels of texture strength based on variance and boundary position jointly. Then the texture strength levels are further combined with the existing classifiers to output the final classification results.

In the present invention, methods and apparatus to simplify multiple in-loop filtering process are disclosed.

### BRIEF SUMMARY OF THE INVENTION

A method and apparatus for in-loop filtering of reconstructed video are disclosed. According to the method, input data for a current block is received, wherein the input data comprises reconstructed samples of the current block. At least two in-loop filters are applied to the current block, wherein said at least two in-loop filters belong to an in-loop filter group comprising BIF (Bilateral Filter) and ALF (Adaptive Loop Filter), and wherein classification processes of said at least two in-loop filters share an input source, one or more classification rules, one or more processing units, or a combination thereof. Filtered output generated by said applying said at least two in-loop filters to the current block is provided.

In one embodiment, the input source shared by the BIF and the ALF corresponds to samples right before or after deblocking filter, residual samples in an original or reshaped domain for the classification processes of said at least two in-loop filters. In one embodiment, the BIF and the ALF are performed in parallel

In one embodiment, the BIF and the ALF share said one or more classification rules. In one embodiment, said one or more classification rules comprise classification determination calculated inside a surrounding region of each processing unit, and wherein the classification determination is based on mean, variance, gradient mean, gradient variance, or a combination thereof. In one embodiment, the BIF and the ALF share one or more operation modules for determining said one or more classification rules. In one embodiment, the BIF and the ALF are performed based on same processing units.

In one embodiment, one or more high-level flags are signalled or parsed to indicate whether the classification processes of said at least two in-loop filters share the input source, said one or more classification rules, said one or more processing units, or the combination thereof.

In one embodiment, the BIF uses the input source corresponding to samples before deblocking filter (pre-DBF) or residual samples.

In one embodiment, BIF classification process calculates variance inside a classification unit. In one embodiment, the classification unit corresponds to a fixed-size block.

In one embodiment, a modifier value for the BIF is derived from a look-up table. In one embodiment, the modifier value is selected from a look-up table based on sample difference, sample distance, QP value, TU size, CU-coded information, or a combination thereof. In one embodiment, one or more flags are signalled or parsed to indicate which of the sample difference, the sample distance, the QP value, the TU size, and the CU-coded information are used to select the modifier value.

In one embodiment, two or more modifier values are selected from the look-up table and said two or more modifier values are blended to generate a final modifier value. In one embodiment, one or more flags are signalled or parsed to indicate whether blending said two or more modifier values is enabled. In one embodiment, one or more flags are signalled or parsed to indicate how said two or more modifier values is blended.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates the ALF filter shapes for the chroma (left) and luma (right) components.

FIGS. 3A-D illustrates the subsampled Laplacian calculations for gᵥ (3A), gₕ (3B), g_{d1} (3C) and g_{d2} (3D).

FIG. 4A illustrates the placement of CC-ALF with respect to other loop filters.

FIG. 4B illustrates a diamond shaped filter for the chroma samples.

FIG. 5 illustrates the 25-tap large filter used in CCALF process.

FIG. 6 illustrates the diamond shaped ALF in ECM-5.0.

FIG. 7 illustrates a longer ALF as an alternative to the diamond shaped ALF in FIG. 6.

FIG. 8 illustrates the filter shape of ALF in ECM-7.0.

FIG. 9 illustrates an example of ALF with additional fixed filter.

FIG. 10 illustrates an example of Bilateral Filter (BIF) with Sample Adaptive Offset (SAO).

FIG. 11 shows the naming convention for samples surrounding the centre sample, I_{C}.

FIG. 12 illustrates an example of bilateral in-loop filter along with SAO (Sample Adaptive Offset) and CCSAO (Cross-Component SAO) for the chroma component.

FIG. 13 illustrates a flowchart of an exemplary video coding system that applies simplified classification process for multiple in-loop filters according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

### Proposed Method

Unified Classification in in-Loop Filtering

In ECM, classification is performed in bilateral filtering (BIF), sample adaptive offset (SAO), cross-component SAO (CCSAO), and adaptive loop filter (ALF). However, the input sources, the rules, and the units of each classification are different. In this invention, some unified classification designs for in-loop filtering are disclosed to reduce the complexity of the in-loop filtering process.

In the following description, BIF classification refers to the derivation of filter multiplier (denoted as c or C_{TU} as described in the background section).

In one embodiment, classification in different in-loop filtering stages (i.e., at least two stages among BIF, SAO, CCSAO, and ALF) shares the input sources, the classification rules, and/or the processing units. Specifically, input sources refer to the information involved in the classification process. For example, in ECM BIF (JVET-AE0044), the input source is the output of deblocking filter (post-DBF) samples; in ECM ALF, there are two input sources, the output of SAO (post-SAO) samples and the residual samples. Classification rules refer to the formula and the look-up tables used in classification process. Processing units refer to the basic unit of classification. For example, in ECM BIF, the processing unit is a TU; in ECM ALF, the processing unit is a 2×2 block.

### Example 1. Classification in BIF and ALF Sharing the Input Sources

Samples right before DBF, samples right after DBF, residual samples in the original domain, and/or residual samples in the reshaped domain are utilized for BIF and ALF classification. In such design, the latency can be reduced since ALF classification can be performed in parallel with BIF classification.

### Example 2. Classification in BIF and ALF Sharing the Classification Rules

Mean, variance, gradient mean, and/or gradient variance inside a surrounding region of each processing unit is calculated for BIF and ALF classification. In such design, the implementation cost can be reduced since ALF classification can reuse the same operation modules from BIF classification.

### Example 3. Classification in BIF and ALF Sharing the Processing Units

The processing unit is a 2×2 block for BIF and ALF classification. Such design is more hardware-friendly since the pipeline of BIF and ALF classification can be easily aligned.

The above examples can be combined, resulting in a more unified design with more implementation benefits.

Combining examples 1 and 2, classification in BIF and classification in ALF share the input sources and same rules. For example, the post-DBF samples are used to derive the variance of each processing unit in BIF and ALF, and the variance are further used for both BIF and ALF classification.

Combining examples 1 and 3, classification in BIF and classification in ALF share the input sources and the processing units. For example, the post-DBF samples are used to derive different statistics of each 2×2 block, and the statistics are further used for both BIF and ALF classification.

Combining examples 1, 2, and 3, classification in BIF and classification in ALF share the input sources, the classification rules, and the processing units. For example, the post-DBF samples are used to derive the variance of each 2×2 block, and the variance are further used for both BIF and ALF classification.

Note that the proposed embodiment emphasizes that there are some shared classification sources and/or operations across the in-loop filtering stages, while differences are still allowed. For example, in BIF, variance is calculated for classification; in ALF, variance and gradient are calculated for classification. Such design is in the scope of the proposed embodiment as long as the operations of variance calculation are the same. For another example, in BIF, post-DBF samples are used for classification; in ALF, given multiple classifiers (e.g., two for fixed filters and three for APS filters in ECM), some of the classifiers utilize the post-DBF samples for classification. Such design is in the scope of the proposed embodiment as well.

For the above embodiment, there can be one or more high-level flags to indicate whether to use the more unified design or not. The shared parts of classification can be explicitly signalled or implicitly determined. As an example of the latter one (implicit method), when shared sources are determined, the classification rules are also implicitly determined. The classification rules can be, for instance, one classification rule for one kind of shared source.

### Improvement and Simplification of BIF

In one embodiment, BIF classification utilizes the samples before deblocking filter (pre-DBF) or the residual samples rather than the output of deblocking filter (post-DBF). In such embodiment, there can be one or more high-level flags to select the classification input source.

In another embodiment, BIF classification calculates the variance inside a classification unit rather than the mean absolute difference. In such embodiment, there can be one or more high-level flags to select the classification rules.

In another embodiment, BIF classification unit is a fixed size block instead of a TU. Specifically, some statistics inside a surrounding region of a block is derived, and the derived statistics are utilized to classify the block. In such embodiment, there can be one or more high-level flags to select the classification unit size.

In another embodiment, the modifier value (denoted as μ_{ΔI}_{_{R}} as described in the background section) is derived from a look-up table, where the value is selected by the sample difference, the sample distance, the QP value, the TU size, and/or the CU-coded information (in JVET-AE0044, the value is selected by the sample difference, the sample distance, and the QP value). In other words, the impact of TU size and CU-coded information (e.g., skip/prediction mode) is moved from the multiplier decision (i.e., classification) to the modifier selection to make the multiplier decision solely depend on block statistics. In such embodiment, there can be one or more high-level flags to select which information to use for the modifier value look up.

### Example 4. The Look-Up Table Containing Five Dimensions, Including the Sample Difference, the Sample Distance, the QP Value, the TU Size, and the CU Mode

Specifically, the first three dimensions follow a similar design to JVET-AE0044. The TU size can refer to the pair of (TU width, TU height), or the minimum/maximum of TU width and TU height. The CU mode refers to skip mode and/or prediction intra/inter mode.

In another embodiment, based on the above embodiment, the modifier value can be derived by blending more than one values from a look-up table, where the additional values are selected by modifying one or some of the look-up table dimensions (i.e., sample difference, sample distance, QP value, TU size, and/or CU-coded information). In such embodiment, there can be one or more high-level flags to select whether the blending mechanism is enabled and/or how to blend the more than one values.

### Example 5. The QP of the Current Processing Sample being q

The modifier value is derived by taking the average of two values, where the two values correspond to q and q+1 in the look-up table.

### Example 6. The QP of the Current Processing Sample being q

If the sample belongs to a skip mode block, the modifier value is derived by taking the average of two values, where the two values correspond to q and q−2. If the sample belongs to a non-skip mode block, the modifier value is directly derived from the look-up table.

### Example 7. At the Boundary of TUs, the Modifier Value being Derived by Taking the Average of Two Values if the Current Processing Sample and a Neighbouring Sample Belong to Different TUs

In this example, the two values correspond to the (QP, TU size, CU mode) triplet of the current processing sample and the triplet of the neighbouring sample.

The foregoing proposed methods of using unified classification process for multiple in-loop filters can be implemented in encoders and/or decoders. For example, the proposed method can be implemented in an in-loop filtering module of an encoder, and/or an in-loop filtering module of a decoder.

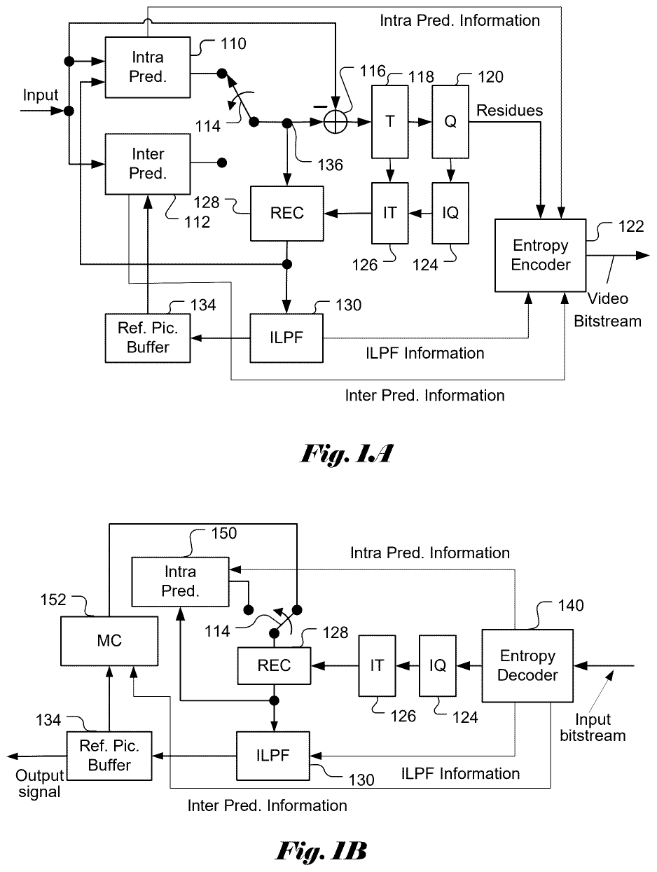

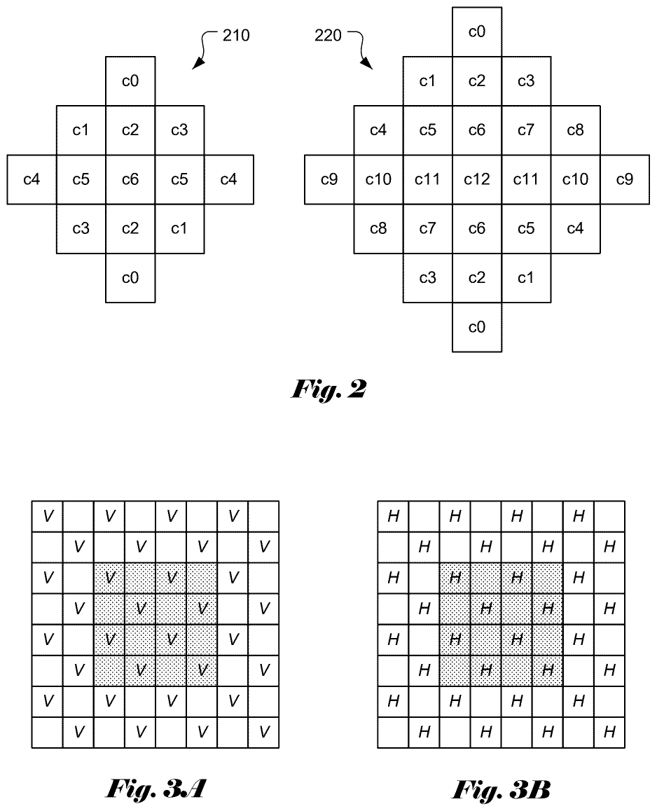

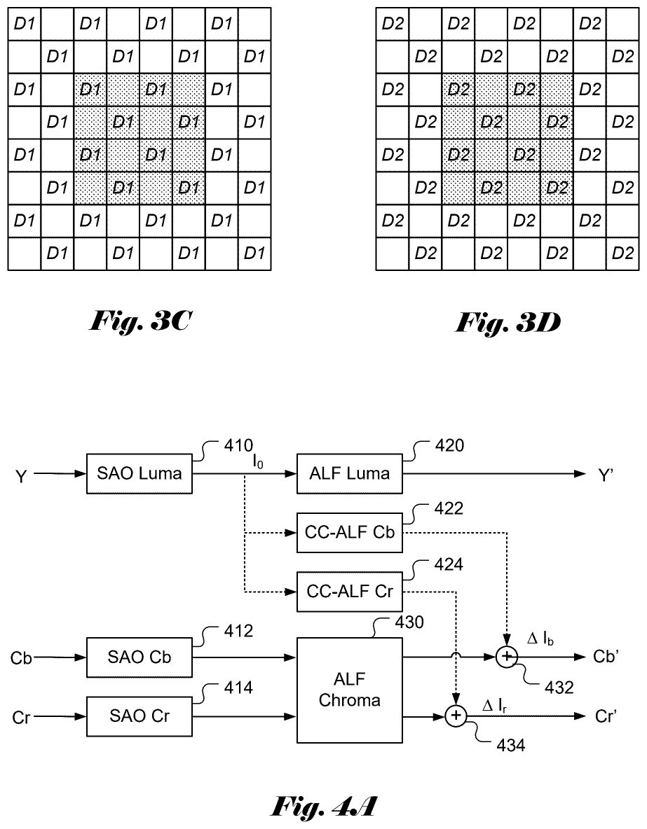

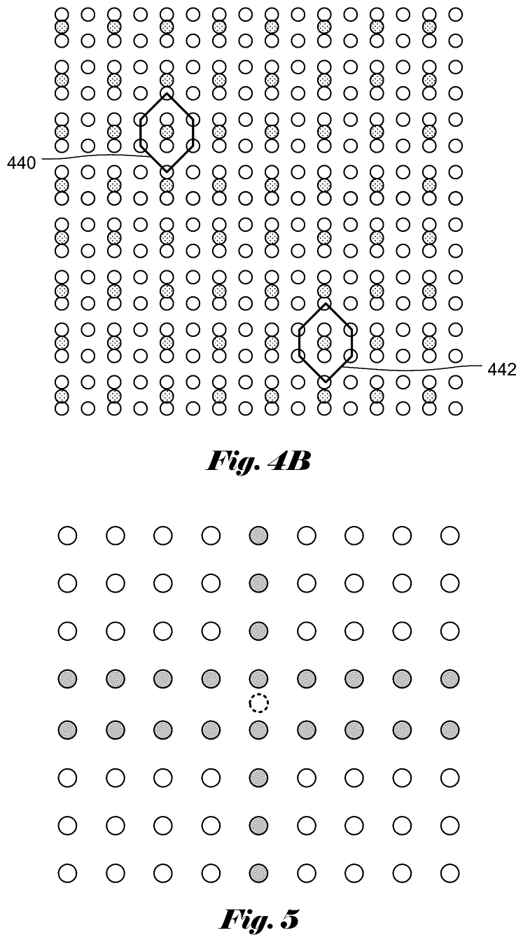

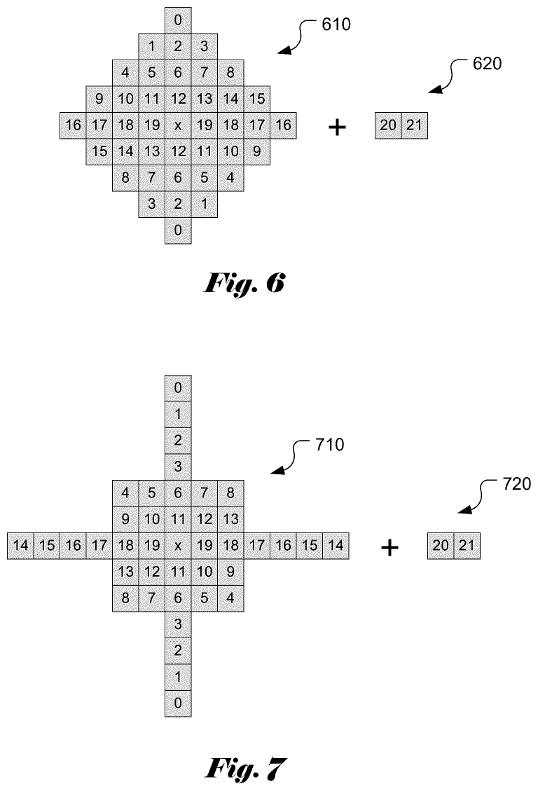

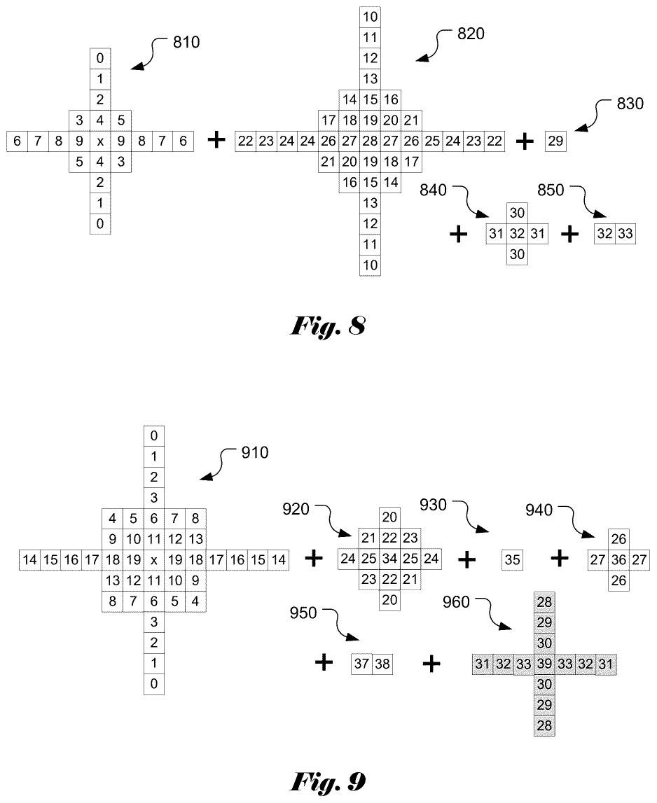

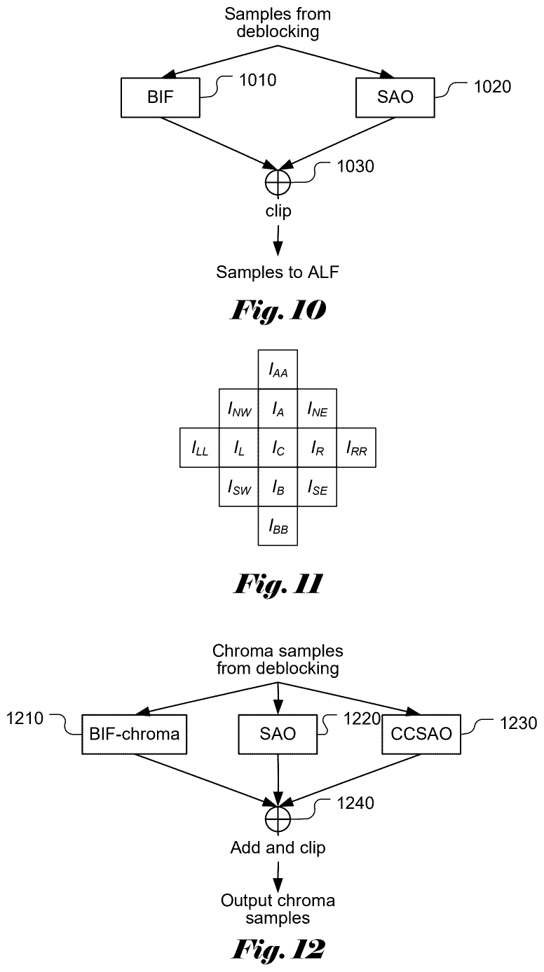

Any of the methods of unified classification process described above can be implemented in encoders and/or decoders. Also, any of the methods of unified classification process described above can be implemented in encoders and/or decoders. For example, any of the proposed methods can be implemented in the in-loop filter module (e.g. ILPF 130 in FIG. 1A and FIG. 1B) of an encoder or a decoder. Alternatively, any of the proposed methods can be implemented as circuits coupled to the inter coding module of an encoder and/or motion compensation module, a merge candidate derivation module of the decoder. The simplified ALF methods may also be implemented using executable software or firmware codes stored on a media, such as hard disk or flash memory, for a CPU (Central Processing Unit) or programmable devices (e.g. DSP (Digital Signal Processor) or FPGA (Field Programmable Gate Array)).

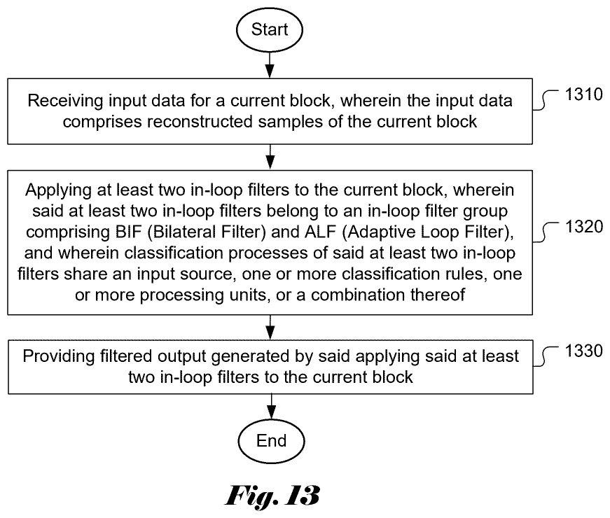

FIG. 13 illustrates a flowchart of an exemplary video coding system that applies unified classification process for multiple in-loop filters according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to the method, input data for a current block is received in step 1310, wherein the input data comprises reconstructed samples of the current block. At least two in-loop filters are applied to the current block in step 1320, wherein said at least two in-loop filters belong to an in-loop filter group comprising BIF (Bilateral Filter) and ALF (Adaptive Loop Filter), and wherein classification processes of said at least two in-loop filters share an input source, one or more classification rules, one or more processing units, or a combination thereof. Filtered output generated by said applying said at least two in-loop filters to the current block is provided in step 1330.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method for in-loop filtering of reconstructed video, the method comprising:
receiving input data for a current block, wherein the input data comprises reconstructed samples of the current block;
applying at least two in-loop filters to the current block, wherein said at least two in-loop filters belong to an in-loop filter group comprising BIF (Bilateral Filter) and ALF (Adaptive Loop Filter), and wherein classification processes of said at least two in-loop filters share an input source, one or more classification rules, one or more processing units, or a combination thereof; and
providing filtered output generated by said applying said at least two in-loop filters to the current block.

2. The method of claim 1, wherein the BIF and the ALF share the input source which corresponds to samples right before or after deblocking filter, residual samples in an original or reshaped domain for the classification processes of said at least two in-loop filters.

3. The method of claim 1, wherein the BIF and the ALF are performed in parallel.

4. The method of claim 1, wherein the BIF and the ALF share said one or more classification rules.

5. The method of claim 4, wherein said one or more classification rules comprise classification determination calculated inside a surrounding region of each processing unit, and wherein the classification determination is based on mean, variance, gradient mean, gradient variance, or a combination thereof.

6. The method of claim 5, wherein the BIF and the ALF share one or more operation modules for determining said one or more classification rules.

7. The method of claim 1, wherein the BIF and the ALF are performed based on same processing units.

8. The method of claim 1, wherein one or more high-level flags are signalled or parsed to indicate whether the classification processes of said at least two in-loop filters share the input source, said one or more classification rules, said one or more processing units, or the combination thereof.

9. The method of claim 1, wherein the BIF uses the input source corresponding to samples before deblocking filter (pre-DBF) or residual samples.

10. The method of claim 1, wherein BIF classification process calculates variance inside a classification unit.

11. The method of claim 10, wherein the classification unit corresponds to a fixed-size block.

12. The method of claim 1, wherein a modifier value for the BIF is derived from a look-up table.

13. The method of claim 12, wherein the modifier value is selected from the look-up table based on sample difference, sample distance, QP value, TU size, CU-coded information, or a combination thereof.

14. The method of claim 13, wherein one or more flags are signalled or parsed to indicate which of the sample difference, the sample distance, the QP value, the TU size, and the CU-coded information are used to select the modifier value.

15. The method of claim 13, wherein two or more modifier values are selected from the look-up table and said two or more modifier values are blended to generate a final modifier value.

16. The method of claim 15, wherein one or more flags are signalled or parsed to indicate whether blending said two or more modifier values is enabled.

17. The method of claim 15, wherein one or more flags are signalled or parsed to indicate how said two or more modifier values is blended.

18. An apparatus for video coding, the apparatus comprising one or more electronics or processors arranged to:
receive input data for a current block, wherein the input data comprises reconstructed samples of the current block;
apply at least two in-loop filters to the current block, wherein said at least two in-loop filters belong to an in-loop filter group comprising BIF (Bilateral Filter) and ALF (Adaptive Loop Filter), and wherein classification processes of said at least two in-loop filters share an input source, one or more classification rules, one or more processing units, or a combination thereof; and
providing filtered output generated by applying said at least two in-loop filters to the current block.
